(19) United States
(12) Patent Application Publication
(10) Pub. No.: US 2001/0002087 A1
(43) Pub. Date: May 31, 2001

(54) HELMET RESTRAINT SYSTEM AND METHOD

(75) Inventor: JOHN A. TOWNSEND, BLOOMFIELD, MI (US)

Correspondence Address: Kristin L. Murrphy, Rader, Fishman & Grauer PLLC, 39533 Woodward Avenue, Bloomfield Hills,, MI, 48304, US

(73) Assignee: John a. Townsend

(21) Appl. No.: 09/141,845

(22) Filed: Aug. 27, 1998

Related U.S. Application Data
(60) Provisional application No. 60/057,116, filed on Aug. 28, 1997.

(51) Int. Cl. B60R 21/00; B60R 22/12; B60R 22/18; B60R 22/46

(52) U.S. Cl. 280/801.1; 297/480; 297/476; 297/479

(57) ABSTRACT

The helmet restraint system of the invention secures the helmet of a driver or passenger occupant of a vehicle, such as a race car, to the structural chassis, body, or frame of the vehicle, independent of the shoulder harness or seatbelt. The system provides a head restraint system which reduces the potentially injurious forces to the neck and head during a high-deceleration event, particularly a frontal collision. The helmet restraint belt system comprises a restraint belt assembly which spans between an anchor point on the vehicle chassis/body and a belt receiving latch mounted to the driver's helmet. The belt is preferably retractable and pre-tensioned by means of a collision or inertially-lockable belt tensioner. The helmet restraint system allows the driver to have unrestricted head movement during normal driving, but restrains the helmet and head during the impact of a collision by locking the belt against further extension. The driver's helmet is attached to the restraint belt by means of a quick-release latch which may be released by the seated driver or a person standing outside the vehicle. Embodiments are disclosed for several different alternative helmet and vehicle mountings of the restraint system, including dual belt, asymmetric restraint systems, and tensioners having internal brake mechanisms that are adjustable to provide tension, either linear or progressive within a preselected range.

### CROSS REFERENCE TO RELATED APPLICATION

This Application is based on U.S. provisional application Ser. No. 60/057,116, filed Aug. 28, 1997 by the same inventor, entitled HELMET RESTRAINT APPARATUS. Applicant incorporates said Application herein by reference and hereby claims the priority date of this earlier filed Application pursuant to 35 U.S.C. § 119(e).

### FIELD OF TECHNOLOGY

The helmet restraint system of the invention pertains to automotive collision safety systems and more particularly to occupant head protection restraints for racing cars and other high-speed vehicles. The inventive restraint system comprises a pre-tensioned, retractable/extensible, collision or deceleration-lockable restraint belt assembly spanning between a releasable mounting to an occupant's helmet and an anchor point on the vehicle chassis, body or frame. The system provides a collision head restraint system which is independent of the seatbelt/shoulder harness and which reduces the potentially injurious forces to the neck and head during a high-deceleration event, particularly a frontal collision.

### BACKGROUND OF THE INVENTION

In race car driving, the driver is typically restrained in his or her seat by a safety harness. During a frontal crash, the race car driver is being propelled forward into the safety harness. The harness stops the torso but does not stop the head from propelling forward. In severe crashes, the forces upon impact cause the head and neck of the race car driver to snap violently forward toward the chest. In such crashes, either the neck or the base of the skull can break, causing serious injury and, in some cases, death. Injuries of this type, called basilar skull injuries, are fairly common in auto racing accidents.

To reduce these injuries, it has been proposed that front air bags be required in Formula 1 Grand Prix race cars. However, many drivers are concerned that after the first impact, the inflated air bag will cause a total lack of vision for the driver. Another problem with air bags in race cars is that they would have to deploy more quickly and with more explosive force than on conventional vehicles because of the high speeds of travel, resulting in potential injury to the driver.

Recently developed technology provides for restraining the movement of the race car driver's helmet, thereby alleviating the need for an air bag. A device known as HANS, uses a high collar around the back of the driver's head attached to the driver's shoulder safety harness. The helmet is attached to this collar by two straps. This safety harness must not only absorb the force of impact created by the driver's body, but also the force of the driver's head and helmet, which in a high-velocity impact becomes a significant increase in the total force restrained by the safety harness. The harness must therefore be recalibrated. Because of its bulkiness, the HANS system makes it more difficult for the race car driver to climb in and out of stock and race cars, and the device does not work well in some supine seating positions. Different size HANS harnesses may be required for different size drivers and/or cockpits. Many drivers refuse to wear the device because it is bulky, uncomfortable and restricts head movement during driving.

What is needed and has not been provided heretofore, is a system for providing better protection for the driver's head and neck in frontal and near frontal impacts, but which does not have the safety, access or vision problems of the prior art.

### SUMMARY OF THE INVENTION

The present invention overcomes the drawbacks outlined above by securing the race car driver's helmet to the structural chassis, body, frame, shell or roll-over structure of the vehicle, independent of the shoulder harness or seatbelt.

The various racing or other vehicles types on which the helmet restraint system of the invention may be employed, such as Formula 1, Indy cars, stock cars, off-road vehicles, etc., may have different types of body, chassis or frame structures or safety reinforcements. Therefore, the generic terms “chassis/body” or “body” will generally be used broadly herein to indicate the structural chassis, body, frame and/or shell assembly of the vehicle, including any roll-over structure, crash reinforcements, or seat structure.

Broadly stated, the inventive helmet restraint belt system comprises a tension-controlled restraint belt assembly which spans between at least one anchor point on the vehicle chassis/body and the driver's (or other occupant's) helmet. The system allows the driver to have unrestricted voluntary head movement by providing a means for the pretensioned extension and retraction of the belt with a gentle (controlled, non-slack, and reduced) restraining during normal driving, but restrains the helmet and head during the impact of a high-deceleration event, such as a collision, by locking the belt against further extension and by providing a restraining tensile load path along the belt from the helmet to the chassis/body.

The driver's helmet is attached to the restraint belt by means of a releasable receiver latch (this may be a conventional seatbelt-type latch and belt mounting bracket or ring) which is molded, bolted, tethered or otherwise fixedly connected to the helmet to releasably receive the belt by means of a mating buckle fixed to the adjacent end of the belt. Alternatively, the buckle may be mounted, tethered or otherwise connected to the helmet, and the receiver latch mounted to one end of the belt. The belt may be constructed of a conventional seatbelt-type woven material such as nylon or dacron. However, the belt tensile strength and elasticity are preferably selected to suit the magnitude of the forces decelerating the helmet and head in a collision, as compared with the greater torso and lower body collision forces exerted on a conventional lap belt/shoulder harness system. While the described embodiments have flattened woven belts, the belt may also comprise a cable or strap of other flexible material of similar strength and elasticity.

The belt assembly connects and spans between the receiver latch and a chassis/body anchor(s). The anchor(s) include(s) both a means of aligning the belt tension direction from helmet to chassis/body (belt aligning engagement) and a means of fixing the belt against linear movement or controlling retraction/extension of the belt (belt mounting). These two means may be separate elements or they may be combined in a single element. The location of the aligning means on the chassis body is called the guide point, and the location of the belt mounting means is called the mounting and anchor point.

The anchor point is preferably adjacent to the driver, at a point generally behind the driver's head at about the height of the mid-point of the driver's head. A typical anchor point is a cross bar member of the anti-rollover bar assembly, or some other suitable chassis/body structural member such as a post or pylon. Where a single-belt restraint system is employed, the belt is preferably directed to an anchor point generally to the rear of the driver's head and generally near head level. If no existing structural element is present in the prior art vehicle at the desired anchor point, a bracket or bar member may be mounted spanning between prior art chassis/body members located on opposite sides of the desired anchor point.

The belt may be directly anchored to the chassis/body by means of a conventional seatbelt-type bracket or D-ring which is bolt-mounted to the chassis frame at the anchor point, and the bracket, in this simple case, comprises both the aligning engagement means and the belt mounting means. However, the belt is alternatively and most preferably mounted to the chassis/body by means of a belt tensioner (this may be a conventional seatbelt-type belt tensioner). The belt tensioner is mounted to the chassis/body and the belt is mounted to the belt tensioner, typically via a spring biased take-up reel, so as to connect the belt to the chassis/body and at the same time maintaining a controlled, gentle tension on the belt during normal driving, eliminating slack while allowing the driver to have normal, unrestricted head movement.

The belt tensioned includes locking means which locks the belt in response to during a high-deceleration event, including but not limited to a collision or crash impact or vehicle loss of control, and is preferably a conventional inertial belt tensioned such as is used in seat belts. Preferably the belt tensioned is calibrated, and the belt length and belt elasticity is preferably preselected, to allow travel of the helmet before stopping which is about equal to and coordinate or coextensive with the movement of the driver's torso in response to the deceleration event as restrained by the seat and shoulder harness. This is typically a travel on the order of 1 to 4 inches, and is dependent on the seat and shoulder harness characteristics, driver weight and the dynamics of the particular deceleration event. Thus the driver's head and neck are cushioned and are permitted to travel in a coordinated fashion with the rest of the body, minimizing head rotation and trauma to the neck and head. As the belt reaches this forward restraint limit point, the restraint apparatus then prevents the head from snapping forward on to the chest, which is a potentially injurious motion exacerbated by the weight of the helmet.

In a typical conventional lockable belt tensioned, the belt is attached at one end to a tensioned spool (take-up reel) rotatably mounted to the tensioned housing, which in turn is anchored to the chassis/body, and the unextended length of the belt is stowed wrapped around spool within the tensioned housing. A torsion spring axially mounted to the spool maintains a pre-selected bias tension (which may be variable or progressive based on belt extension) on the belt while allowing the belt to be incrementally extended or retracted from the spool upon driver head movement. A ratchet-type spool locking device mounted to the tensioned housing is activated in response to the inertial forces of a deceleration event to lock the spool against further belt release. The locking activation may be directly by an impact-sensitive device such as an accelerometer within the tensioned housing or indirectly by means of a remote sensor.

The belt tensioned may be mounted by direct attachment, such as by bolts, to the chassis/body or may be anchored by a tether strap mounted to the chassis/body. Alternative belt tensioned systems are feasible, if provided with a suitable impact sensitive locking device, which mount a tensioning/retraction spool to the mid portion of the belt, with the belt end being anchored to the chassis/body.

The belt mounting point does not need to be closely adjacent to the engagement or anchor point, and may be removed some selected distance. The belt may be attached by sliding engagement at the anchor point to a chassis/body structural member, such as a frame tube or bar, which only maintains the belt alignment, and leads the belt to extend to another location for mounting of the belt end to the chassis/body. In the principal embodiments, this aligning is by sliding engagement to a rounded cross bar mounted horizontally and laterally to the chassis/body in the center portion of the roll-over structure behind the driver's head. The belt is led over and around the cross bar through a turning angle to direct the belt downward to an mounting on the belt tensioned, which is in turn mounted on the lower portion of the chassis/body. The belt tensioned is preferably mounted directly to the chassis/body at the belt mounting point which serves as the ultimate anchoring point. The slidable attachment or engagement of the belt to the cross bar may be supplemented by a simple belt-retainer strap mounted on the cross bar sideways over the belt, in the manner of a pants belt loop, to prevent the belt from slipping out of its alignment position on the bar.

One advantage of the indirect anchoring arrangement describe above, it that it permits substantial length of belt to be used even where the chassis/body anchor point is located close behind the driver's head, since the belt may extend a substantial distance beyond the anchor point. The elastic properties of the belt material and belt length may then be preselected to regulate the amount of the belt stretch under impact forces and to thus control the deceleration distance and forces transmitted to the helmet and driver's head subsequent to the belt tensioner locking upon collision impact or high-deceleration event.

Alternative to the sliding aligning engagement described above, an alignment means may be employed mounted to the chassis/body, such as a pulley-type device, a guide ring or guide tube. Where the belt tensioner is mounted to a point on the chassis/body or other vehicle structure located behind the driver's head at about head level, such as on a seat headrest, the belt will remain aligned without any separate alignment means.

As an alternative to anchoring the restraint system to the chassis/body directly, the restraint system may be anchored to a structurally reinforced seat or seat-mounted rear head support, transmitting the helmet collision deceleration forces through the seat structure and seat attachment fittings to the chassis/body. This permits a driver-customized or specially fitted seat and helmet restraint system combination to be quickly removed from one vehicle and reinstalled in another vehicle.

The receiver latch may be directly mounted onto or integral with the helmet, or may be mounted to a short tether, which in turn is mounted to the helmet. The tether may include a single tether strap mounted to one point on the helmet, such as the top or back, or it may include a plurality of a tether straps, mounted to a plurality of points on the helmet, such as to each helmet side.

In order to quickly detach the helmet from the belt, a conventional seatbelt-type belt quick release means, such as a push-button or lever-type quick release, is preferably incorporated into the belt receiver latch. This quick-release can be operated by the seated driver, or by a crew member, or rescuer standing outside the car.

Alternatively to, or in addition to, a restraint belt system directed generally rearward as described above, the helmet restraint belt system may be mounted as a pair (or more) of restraint belt assemblies directed laterally to the left and right or directed at an angle having a rearward and/or downward component, in addition to a lateral component. As thus mounted, the pair of restraint belt assemblies may exert belt tensioner bias forces which can help to restrain lateral head motion due to cornering vehicle accelerations not compensated for by roadway banking, particularly where the belt tensioner is designed to have a progressive bias tension, i.e., the bias tension increases as belt is extended and decreases as belt is stowed. In addition, as thus mounted, the restraint system can restrain lateral head motion due to side collision impacts.

Other advantages and objects of the inventive helmet restraint system will be evident for the following detailed description and figures.

### BRIEF DESCRIPTION OF THE DRAWINGS

FIG. 1A is a perspective view showing a first embodiment of a helmet restraint system constructed according to the present invention;

FIG. 1B is a side elevation view showing first embodiment of FIG. 1A;

FIG. 2 is a rear three-quarters perspective view showing second embodiment of the invention;

FIG. 3 is a perspective view showing a third embodiment of the invention;

FIG. 4A is a perspective view showing a fourth embodiment of the invention;

FIG. 4B is a perspective view similar to FIG. 4A showing a different angle of the fourth embodiment;

FIG. 5 is a perspective view showing a fifth embodiment of the invention; and

FIG. 6 is a perspective view showing a sixth embodiment of the invention.

### DETAILED DESCRIPTION OF THE BEST MODE OF THE INVENTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what is presently believed to be the best mode of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

In the following descriptions, the reference numerals which refer to comparable or homologous elements of the different embodiments of the helmet restraint system and apparatus of the invention contain the same last digit, the first digit being indicative of the particular embodiment number. Reference numerals which refer to vehicle structural elements are the same in each figure.

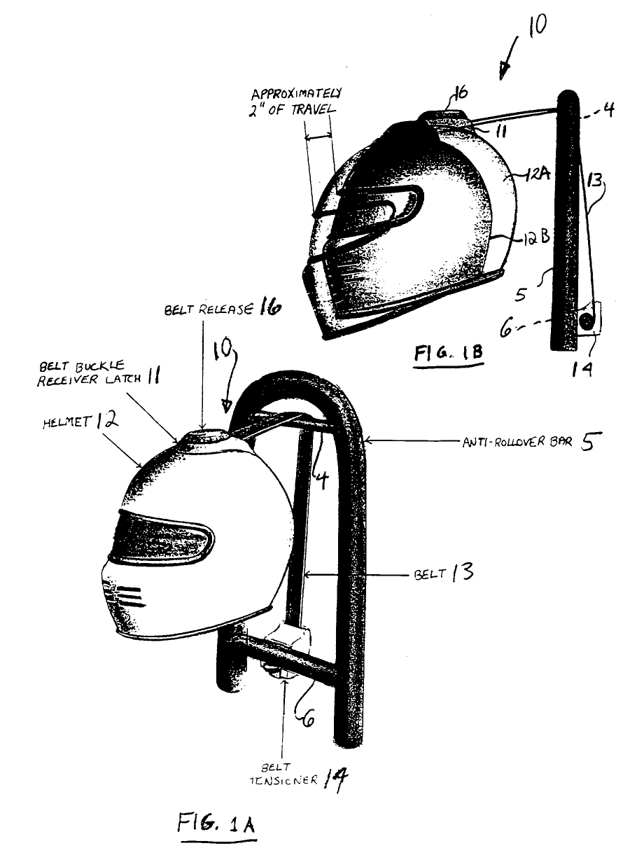

FIGS. 1-6 depict several embodiments of the helmet/head restraint system of the invention. In each figure, the helmet restraint system is shown installed to a typical conventional anti-rollover bar assembly (roll bar) 5, which includes an upper cross bar 4 adjacent the head of driver D and a lower cross bar 6 adjacent the shoulder area of driver D. It should be noted that each embodiment of the invention may be installed on different types of roll bars, and alternatively on other vehicle structural elements.

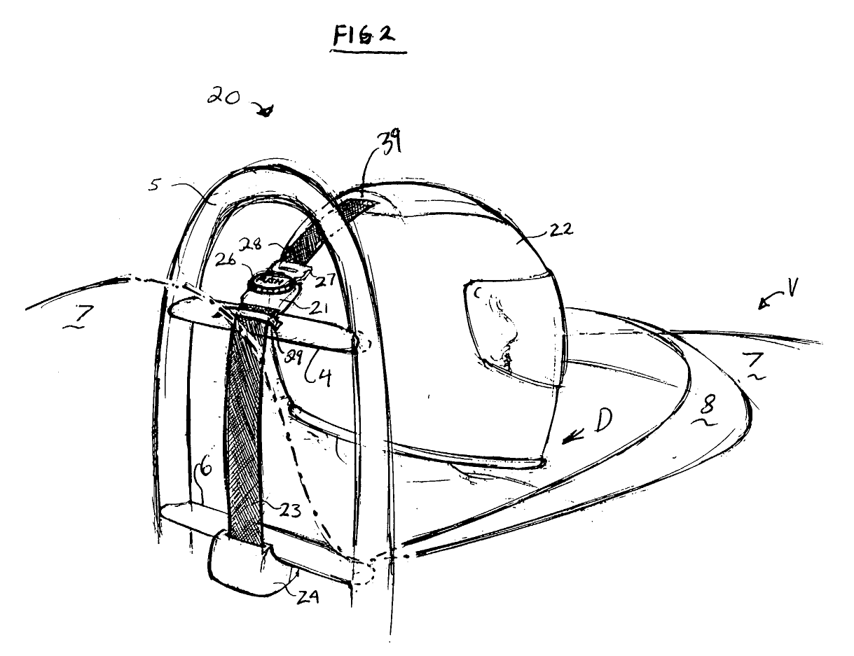

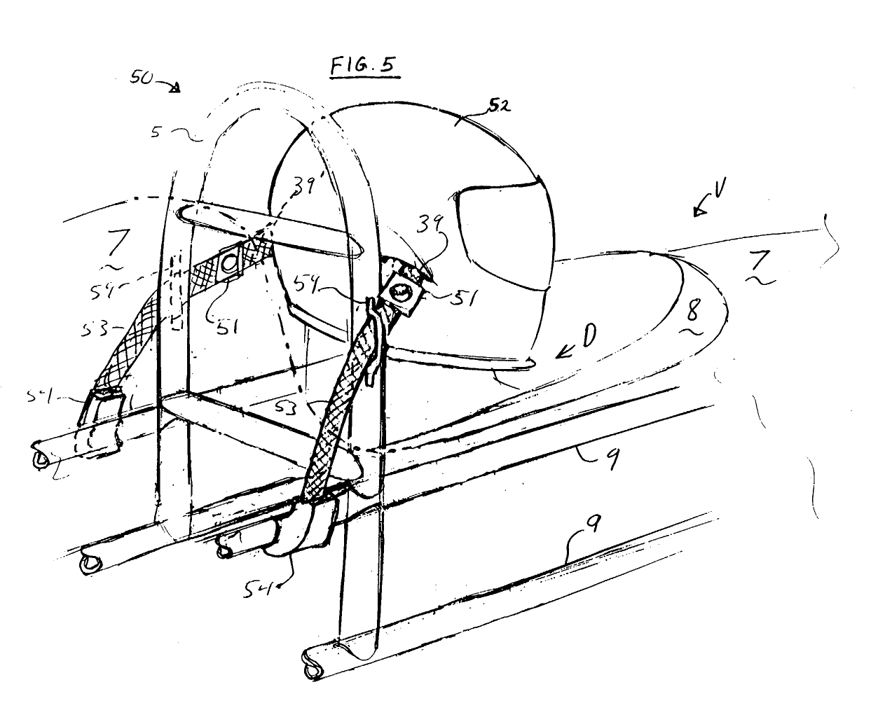

In FIGS. 2-6 the embodiments are shown as installed in an exemplary Formula 1 type vehicle V, and show the driver D seated in cockpit area of the vehicle V, in perspective view from the right rear, including the windshield 8 and the surrounding portion of chassis/body 7. The portion of the chassis/body 7 in the left-hand side of each figure is depicted in phantom lines, to more clearly show the underlying elements of the restraint system. The roll bar 5 is shown installed adjacent the rear cockpit area, the rigid mountings of the roll bar 5 to chassis/body 7 are not shown, except in FIG. 5.

Referring to FIGS. 1A and 1B, a first embodiment 10 of the inventive restraint system is shown. A belt buckle receiver latch 11 is molded into, bolted or screwed onto, or otherwise attached to the top of helmet 12 to receive belt 13. Belt 13 extends over an upper cross-bar 4 (guide point) mounted to anti-rollover bar (roll bar) 5, from a belt tensioner 14 which is attached to a lower cross-bar member 6 (belt anchor mounting point) mounted to roll bar 5, or some other suitable chassis/body structural member (the mounting of the roll bar 5 to the vehicle is conventional and is not shown). Belt tensioner 14 preferably allows for approximately 2 inches of deceleration travel before locking, as shown in FIG. 1B, thus cushioning the arresting impact to the head and neck. As it reaches this forward point, the restraint apparatus now prevents the head from snapping forward into the chest, a motion exacerbated by the weight of the helmet 12. The initial position of the helmet is indicated in FIG. 1B as 12A and the forward position as 12B. In order to quickly detach helmet 12 from belt 13, a conventional belt release 16 is mounted atop belt receiver 11, and can be operated by the driver, or a crew member or rescue person from outside the car.

Referring to FIG. 2, a second embodiment 20 of the present invention is shown. Instead of attaching receiver 21 to the top of helmet 22 as in the first embodiment, belt portion or tether 28 itself can be molded, bolted, or otherwise fastened to helmet 22. The tether 28 is shown fastened at the top of helmet 22 at point 39, but may also be fastened adjacent the midpoint of the back of helmet 22. Belt buckle 27 extending from belt portion 28 clips and attaches into receiver 21, which is placed adjacent to an upper cross-bar 4 of anti-rollover bar 5 at approximately a height ranging from the midpoint to the top of helmet 22. Belt release 26 is incorporated into receiver 21. Belt 23 slidingly engages crossbar 4 (anchor point) and extends over and around cross-bar 4 to extend downward to mount to belt tensioner 24, which is bolted or otherwise fixedly anchored to lower cross bar 6 (mounting point) of roll bar 5. Retainer strap 29 extends parallel to the crossbar 4 over the belt 23 to mount to upper crossbar 4 on each side of belt 23, to prevent the belt from moving sideways along the bar and to prevent receiver 21 from retracting over the crossbar 4. Retainer strap 29 can range from stiff plastic to metal, but should be chamfered on the edges to insure the belt is not cut upon impact.

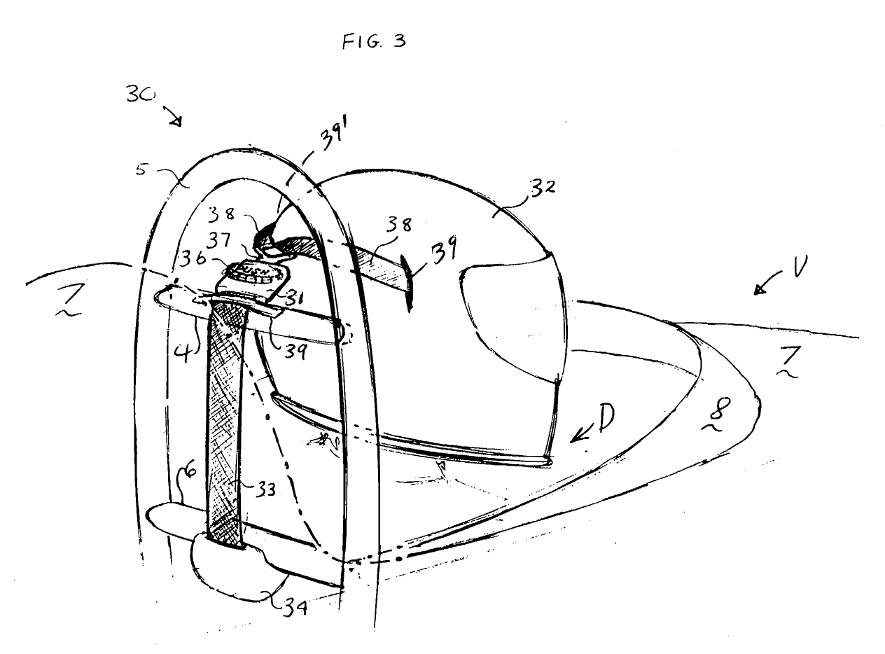

Referring to FIG. 3, the third embodiment 30 of the present invention is shown. In the manner of the second embodiment shown in FIG. 2, the belt 33 extends from receiver 31, over crossbar 4 and under retainer strap 39, extending downward to mount to belt tensioner 34 which is mounted to lower crossbar 6. However, instead of one belt located at the top of helmet 32, a pair of tether straps 38 are molded, bolted, on otherwise fastened on each side of helmet 32 and extend to mount to buckle 37 located adjacent the rear of helmet 32. In this instance, buckle 37 provides an angle-sided aperture for straps 38 and clips into receiver 31 between anti-rollover bar 5 and the back of helmet 32. This arrangement is preferred, as by selection of the attachment points 39, 39′ to the helmet 32, the tether straps 38 collectively act through the combined center of gravity of the driver's head and helmet 32 to prevent rearward rotation of the head (lifting of the chin) during deceleration.

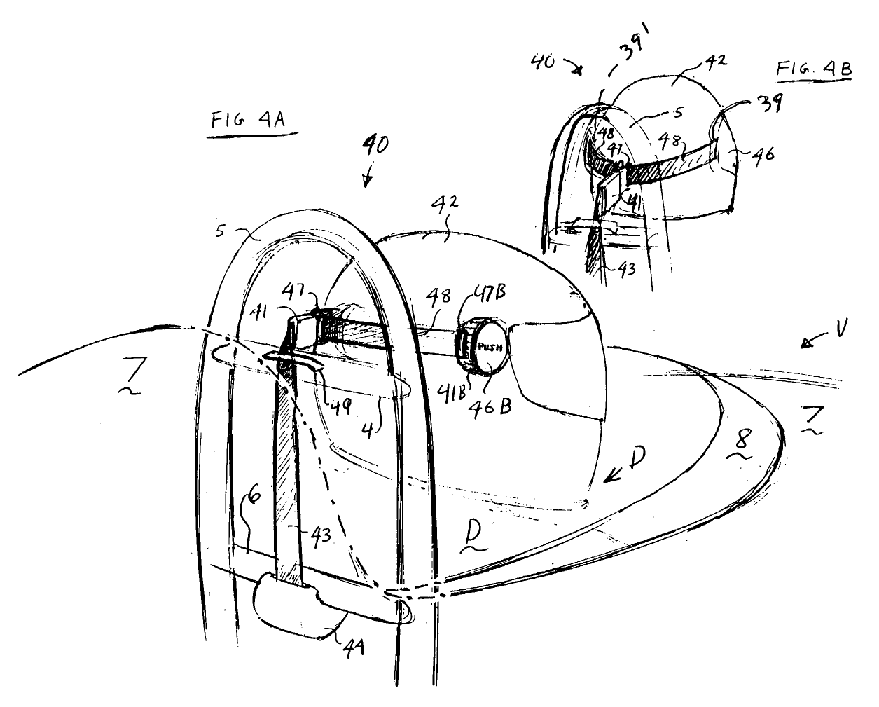

Referring to FIGS. 4A and 4B, a fourth embodiment 40 of the present invention is shown. In the manner of the third embodiment shown in FIG. 3, the belt 43 extends from releasable receiver 41, over crossbar 4 and under retainer strap 49, extending downward to mount to belt tensioner 44 which is mounted to lower crossbar anchor 6. This is a variation of the previous embodiment, having tether strap 48 extending through an aperture in buckle 47 attached to receiver 41, to attach at each end of tether strap 48 to each side of helmet 42. However, at least one side buckle 47B is mounted to the one end of tether strap 48, and is clipped and attached into side receiver 41B mounted to the side of helmet 42 or from receiver 41. Side release 46B is located over strap 48 where it attaches to helmet 42 so that the tether strap 48 may be directly released from the helmet 42. Side buckle 47B is preferably selected to be small enough in thickness and width to allow it to slide through buckle 47 when the strap 48 is released from the side receiver 41B. In an alternative, buckle assembly 41B, 47B can optionally be repeated on the left side of helmet 42. Belt release 46B can replace or be in addition to a belt release located on buckle receiver 41.

FIG. 4B shows another alternative, in which the tether strap 48 is directly fixed to the helmet 42 at 39, 39′, there being only one release at 41.

Referring to FIG. 5, a fifth embodiment 50 of the present invention is shown. Instead of utilizing a single belt, two belts 53 are used, each running down to a belt reel 54 located on opposite sides of the vehicle as mirror images of one another, and attach to the chassis/body side framework 9. The alignment retainer clip 59 is located generally laterally and optionally rearwardly of the driver's head. A belt receiver 51 is attached to the end of each belt 53 adjacent retainer strap 59 located on the chassis/body frame 9. A belt portion or tether 58 is molded, bolted, or otherwise fastened to each side of helmet 52. Each tether 58 includes a belt buckle (not shown, being recessed into the receiver 51) which is engaged by belt receiver 51. Thus, two belt reels 54, two belts 53, two receivers 51, two belt buckles, and two belt segments 58 are required. Belts 53 are tensioned in such a way as to restrain the head from being pulled side-to-side by the lateral G-forces which build up as the car's speed increases in a bend or on an oval track. As in the previous embodiments, belts 53 lock into place during violent deceleration travel cause by a crash having a main frontal component. This embodiment may alternatively and optionally be used in combination with an embodiment such as is shown in FIGS. 1-4.

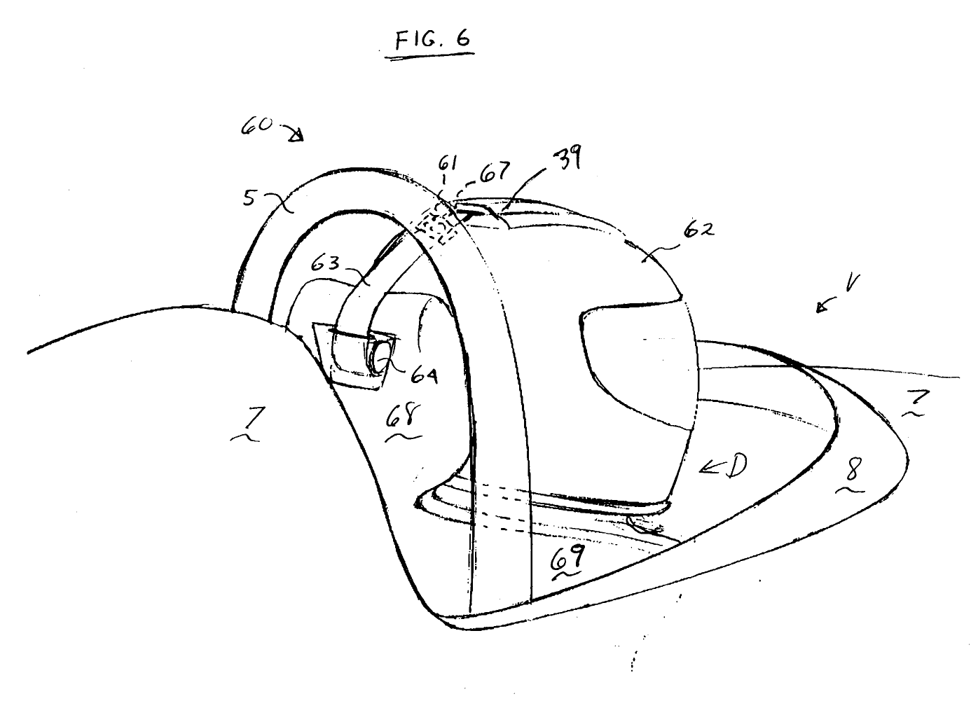

Referring to FIG. 6, a sixth embodiment 60 of the present invention is shown. In this embodiment, the receiver 61 and buckle 67 may be mounted or tethered to the helmet at 39, in the manner of any one of the embodiments of FIGS. 1-4. Belt 63 is anchored to belt tensioner 64 which is mounted on or in the seat headrest 68 of driver's seat 69 rather than being mounted to the vehicle chassis/body. The driver's seat is firmly bolted or otherwise mounted to the chassis/body of the race car (the seat mounting is conventional and is not shown). The principal advantage of this embodiment is that the restraint system will remain accurately adjusted for a particular driver, even though for one reason or another he or she may transfer to an alternate race car. It is common practice to transfer the driver's personalized seat to the new vehicle. In the previous embodiments when the head restraint apparatus is attached to the vehicle chassis/body, and adjustment may be desired to accommodate each new driver.

Industrial Applicability

It is clear that the helmet restraint system of this invention, employing a tension-controlled, collision-lockable restraint belt assembly which spans between an anchor point on the vehicle chassis/body and the driver's helmet, has wide industrial applicability to a wide variety of racing vehicle types. This is particularly so in consideration of the important need to protect against injuries due to inertial forces on the head and neck during frontal collisions and other high-deceleration events, and in light of the inability of conventional seatbelts and shoulder harnesses to provide the needed level of protection. It may also be employed in off-road vehicles, helicopters, aerospace vehicles, parachute or escape capsule harnesses and other applications where maximum head protection against high acceleration is a requirement.

It should be understood that various modifications within the scope of this invention can be made by one of ordinary skill in the art without departing from the spirit thereof. For example, the tension on the belt may be preselected constant (linear) or progressive, or, a brake may be internal to the reel mechanism to provide adjustable tension within a preselected range. This is particularly useful in the 2-belt system where the tensions are not equal on each side of a neutral (centered) position, with tensions being asymmetric, e.g. for a track having only left turns, the tension on the left belt may be greater than the right one. I therefore wish my invention to be defined by the scope of the appended claims as broadly as the prior art will permit, and in view of the specification if need be.

PARTS LIST

| +E,uns V | +E,uns vehicle |
|---|---|
| D | driver |
| 4 | upper cross bar |
| 5 | anti-rollover bar |
| 6 | lower cross bar |
| 7 | chassis/body |
| 8 | windshield |
| 9 | frame |
| +E,uns 10 | +E,uns first helmet restraint embodiment |
| 11 | belt buckle receiver latch |
| 12 | helmet |
| 13 | belt |
| 14 | belt tensioner |
| 16 | conventional belt release |
| +E,uns 20 | +E,uns second helmet restraint embodiment |
| 21 | receiver |
| 22 | helmet |
| 23 | belt |
| 24 | belt tensioner |
| 26 | release |
| 27 | belt buckle |
| 28 | belt portion or tether strap |
| 29 | belt retainer strap or clip |
| +E,uns 30 | +E,uns third helmet restraint embodiment |
| 31 | receiver |
| 32 | helmet |
| 33 | belt |
| 34 | belt tensioner |
| 36 | release |
| 37 | buckle |
| 38 | belt portions or tether straps |
| 39 | helmet mounting points (generic) |
| +E,uns 40 | +E,uns fourth helmet restraint embodiment |
| 41 | buckle receiver |
| 42 | helmet |
| 43 | belt |
| 46 | belt release |
| 47 | buckle |
| 48 | belt portion or tether strap |
| 49 | retainer strap or clip |
| +E,uns 50 | +E,uns fifth helmet restraint embodiment |
| 51 | belt receiver |
| 52 | helmet |
| 53 | two belts |
| 54 | belt tensioner |
| 59 | retainer strap or clip |
| +E,uns 60 | +E,uns sixth helmet restraint embodiment |
| 61 | belt receiver |
| 63 | belt |
| 64 | belt tensioner |
| 67 | belt buckle |
| 68 | seat headrest |
| 69 | seat |

What is claimed is:

1. A helmet restraint system, for use by an occupant wearing a helmet and seated in a seat within the interior of the body of a motor vehicle, comprising in operative combination:
(a) at least one belt having a first end and a second end;
(b) releasable receiving latch connected to at least one of the helmet and the first end of the belt;
(c) a mating buckle releasably receivable within the receiving latch and connected to the other of the helmet and the first end of the belt; and
(d) a lockable retracting belt tensioner attached to the second end of the belt and anchoringly mounted to at least one of the seat and the body, to lock the belt against extension during a high-deceleration event; and
(e) said lockable belt tensioner includes a take-up reel to retain a retracted portion of said belt intermediate said first and second belt ends and watch permits free movement of the occupant's head during normal driving.

2. A helmet restraint system as in claim 1, further comprising a belt aligning means mounted to at least one of the seat and the body, said aligning means guidingly engaging said belt intermediate the first and second belt end in a preselected direction to said helmet.

3. A helmet restraint system as in claim 2, wherein the belt aligning means comprises sliding engagement of the belt with a body structural member at a point about at head level and generally behind the occupant.

4. A helmet restraint system as in claim 1, wherein the belt tensioner is mounted at a point generally behind the occupant and at about occupant head level to provide a preselected belt direction to said helmet.

5. A helmet restraint system as in claim 1, wherein the receiving latch includes a quick-release feature.

6. A helmet restraint system as in claim 1, wherein the belt tensioner limits head movement during a high-deceleration event to movement substantially coextensive with the occupant's torso movement.

7. A helmet restraint system as in claim 1, wherein one of the mating buckle and the receiving latch is fixedly mounted to the helmet.

8. A helmet restraint system as in claim 1, wherein one of the mating buckle or the receiving latch is connected to the helmet by a connecting means aligned so that the tension force of the belt acts along a line of action passing substantially through the collective center of gravity of the occupant's head and helmet, to minimize rotation of the occupant's head during a high-deceleration event.

9. A helmet restraint system as in claim 1, wherein one of the mating buckle or the receiving latch is flexibly connected to the helmet by at least one tether strap, the tether strap being mounted to both the helmet and the buckle.

10. A helmet restraint system as in claim 9, wherein the tether strap has two ends, one end mounted to on each side of the helmet by a tether mounting means, and an intermediate portion of the tether strap passing through an aperture formed in the buckle.

11. A helmet restraint system as in claim 10, wherein the tether mounting means at least one side of the helmet is a tether buckle fixed to end of the tether and receivingly engagable within a receiving latch mounted to the same side of the helmet.

12. A helmet restraint system as in claim 1, further comprising:
(a) a spaced, opposingly disposed pair of helmet restraint systems mounted in substantially mirror image fashion, one system being mounted to each side of the helmet; and
(b) each belt being anchoringly mounted generally laterally and rearwardly of the occupant's head, so that the belt tension has a substantial lateral component acting upon the helmet, to provide lateral support to the occupant's head during normal driving, and to restrain the motion of said helmet in a high-deceleration event.

13. A helmet restraint system as in claim 1, wherein:
(a) the belt tension is anchoringly mounted to the seat independent of other elements of the body so that the restraint system moves with movement of the seat upon adjustment thereof.

14. A helmet restraint system as in claim 1 wherein said belt tension includes a tension adjustment means to adjust linear or progressive tension on said belt within a preselected range.

15. A method of protecting a seated vehicle occupant against head and neck injuries due to inertial movement of the head during high-deceleration events, wherein the occupant is wearing a helmet and a torso belt-type restraint, comprising the steps of:
(a) maintaining a controlled first limited restraining tension on the helmet to permit free movement of the occupant's head during normal driving; and
(b) increasing the restraining tension on the helmet to restrain the helmet against inertial movement of the head upon the occurrence of a high-deceleration event, to control the movement of the head and neck to be substantially coextensive with inertial movement of the occupant's torso.

16. A method of protecting a seated vehicle occupant against head and neck injuries due to inertial movement of the head during high-deceleration events, wherein the occupant is wearing a helmet and a torso belt-type restraint, comprising the steps of:
(a) connecting the helmet with a vehicle body member by means of an extensible/retractable tension member mounted to said body member and releasably mounted to the helmet; and
(b) controlling the tension force on said tension member to permit free movement of the occupant's head during normal driving; and
(c) locking said tension member against extension during a high-deceleration event, to control the movement of the head and neck to be substantially coextensive with inertial movement of the occupant's torso.
